(19) United States
(12) Patent Application Publication
(10) Pub. No.: US 2025/0353051 A1
(43) Pub. Date: Nov. 20, 2025

(54) Equipment and Method for Intelligent Mobile Medical Waste Disposal and Flue Gas Purification

(71) Applicant: University of Chinese Academy of Sciences, Beijing (CN)

(72) Inventors: Yang Chen, Beijing (CN); Tongzhe Wang, Beijing (CN); Qinzhong Feng, Beijing (CN); Liyuan Liu, Beijing (CN); Jianbo Guo, Beijing (CN); Han Liu, Beijing (CN); Zhibin Yin, Beijing (CN); Guiying Liu, Beijing (CN)

(21) Appl. No.: 18/810,178

(22) Filed: Aug. 20, 2024

(30) Foreign Application Priority Data
May 17, 2024 (CN) 2024106154473

(51) Int. Cl. B09B 3/40; B01D 53/78; B09B 101/65; F23G 5/40

(52) U.S. Cl. CPC B09B 3/40; B01D 53/78; F23G 5/40; B01D 2258/0291; B09B 2101/65; F23G 2209/20

(57) ABSTRACT

Provided are equipment and methods for intelligent mobile medical waste disposal and flue gas purification, and the equipment includes a vehicle-mounted mobile platform and a skid-mounted standard container; where, the vehicle-mounted mobile platform is composed of a standard semi-trailer truck and a truck carriage base; the vehicle-mounted mobile platform is used for realizing functions of mobile transportation, cargo loading, fuel loading and unloading, power charging and discharging and network information transmission; the skid-mounted standard container is loaded above the truck carriage base of the vehicle-mounted mobile platform; and the skid-mounted standard container consists of a standard container and contents in the standard container; and the contents include: an intelligent collection and transportation feeding system, a medical waste pyrolysis incineration system, an incineration flue gas purification system, and an intelligent management and control system for medical waste disposal.

### CROSS-REFERENCE TO RELATED APPLICATIONS

This application claims priority to Chinese Patent Application No. 202410615447.3, filed on May 17, 2024, the contents of which are hereby incorporated by reference in their entirety.

### TECHNICAL FIELD

The disclosure relates to the fields of medical waste pyrolysis incineration disposal, research and development of incineration exhaust purification equipment, integrated development of small mobile skid-mounted equipment, and research and development of supporting intelligent management and control platform, and in particular to equipment and a method for intelligent mobile medical waste disposal and flue gas purification.

### BACKGROUND

Medical waste (including medical waste and epidemic-related domestic waste) has great potential harm to the ecological environment and human health because of its infectious and toxic characteristics. The research and development of medical waste disposal technology, especially technology relating to disposal of the substantial infectious waste generated during an epidemic, is an environmental challenge that the world has been paying close attention to for a long time. In-situ disposal by pyrolysis incineration is one measure to make up for the shortcomings of medical waste disposal at the grass-roots level and in epidemic situations.

The generation and disposal of medical waste is a common concern of all countries in the world. Since the outbreak of severe acute respiratory syndrome (SARS), China has initially formed a pollution prevention and control technical pattern with centralized disposal as the core and incineration technology (rotary kiln, fixed bed) and non-incineration technology (high temperature steam, chemistry, microwave, high temperature dry heat, etc.). Facing the new situation of corona virus disease 2019 (COVID-19) epidemic, China's central government put forth the new requirement of “speeding up the filling of shortcomings in medical waste and hazardous waste collection and treatment facilities”. Compared with non-incineration technology, pyrolysis incineration technology is more in line with the needs of miniaturized in-situ disposal because of its thorough disinfection and sterilization, high degree of reduction, and is conducive to solving the problems of wide dispersion, high collection and transportation risk and flexible disposal ability of medical waste under epidemic situation and grass-roots conditions. Therefore, it is an urgent problem for China to develop miniaturized in-situ quick start-stop safety disposal technology and equipment based on pyrolysis incineration, and establish a matching technical management system and commercialization promotion model. Domestic and foreign research and application practice show that although pyrolysis incineration technology has many advantages, it faces a number of problems that need to be tackled in system configuration, unit design and pollution prevention and control due to the idea of in-situ miniaturization of the disposal.

In the process of equipment integration, the key point is to meet the requirements of miniaturization, mobility and frequent start-stop, and to develop related supporting vehicle, energy supply, automatic control and intelligent supervision systems. In the field of research and development and manufacturing of medical waste disposal equipment, there are representative enterprises such as Nanjing Zhongchuan Oasis Environmental Protection Co., Ltd. (medical waste comprehensive incineration disposal system), Chongqing Zhide Thermal Engineering (centralized medical waste high-temperature steam treatment equipment), China Energy Conservation and Environmental Protection Equipment Co., Ltd. (small and medium-sized medical waste pyrolysis gasification equipment) and Henan Liying Environmental Protection Science and Technology Co., Ltd. (medical waste vehicle-mounted and intelligent management system, which was used to support the epidemic in Hubei Province and reported by China Central Television (CCTV)). However, there is a relative lack of research and development of small mobile pyrolysis incineration devices and skid-mounted pollution control equipment, and there is also a need to develop different equipment with feasible equipment and economic efficiency in combination with actual domestic demand.

### SUMMARY

The following presents a summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere herein.

In view of the shortcomings of the prior art, the disclosure provides systems and methods for intelligent mobile medical waste disposal and flue gas purification. In some aspects, the teachings realize the integration of miniaturized mobile skid-mounted pyrolysis incineration complete sets of equipment, intelligent supervision and intelligent optimization of whole space search, and overcome the technical problems of great changes in flue gas pollution components and concentrations, high requirements for miniaturization of equipment, frequent and rapid start-stop adaptability and the like.

In some examples, the disclosure provides the following scheme.

Intelligent mobile medical waste disposal and flue gas purification equipment, including a vehicle-mounted mobile platform and a skid-mounted standard container;
where, the vehicle-mounted mobile platform is composed of a standard semi-trailer truck and a truck carriage base; the vehicle-mounted mobile platform is used for realizing functions of mobile transportation, cargo loading, fuel loading and unloading, power charging and discharging and network information transmission;
the skid-mounted standard container is loaded above the truck carriage base of the vehicle-mounted mobile platform; and
the skid-mounted standard container consists of a standard container and contents in the standard container; the contents include: an intelligent collection and transportation feeding system, a medical waste pyrolysis incineration system, an incineration flue gas purification system, and an intelligent management and control system for medical waste disposal.

Optionally, the intelligent collection and transportation feeding system includes an intelligent mechanical arm, high-temperature sterilization equipment, spray sterilization equipment, ultraviolet sterilization equipment and vehicle-mounted fire-fighting equipment;
where, the intelligent mechanical arm is automatically controlled by the intelligent management and control system for medical waste disposal, and automatically feeds the medical waste pyrolysis incineration system to realize unattended “zero contact” with medical waste;
the high-temperature sterilization equipment, the spray sterilization equipment and the ultraviolet sterilization equipment are combined together to complete compound sterilization of the intelligent mobile medical waste disposal and flue gas purification equipment, and realize “zero diffusion” of medical waste infectivity; and
the vehicle-mounted fire fighting equipment is automatically controlled by the intelligent management and control system for medical waste disposal, and a standard fire extinguisher and a fire alarm probe are built in for an emergency fire extinguishing function in an event of an unconventional fire of the intelligent mobile medical waste disposal and flue gas purification equipment.

Optionally, the medical waste pyrolysis incineration system includes a pyrolysis gasification chamber and a secondary combustion chamber;
where a flue gas outlet of the pyrolysis gasification chamber is connected with an inlet of the secondary combustion chamber;
the pyrolysis gasification chamber adopts rapid pyrolysis temperature-increasing components and an adaptive tower-type rotating grate, and spiral fins are added to an inner/outer wall surface of a pyrolysis cylinder, and the intelligent mechanical arm automatically feeds a feeding port of the pyrolysis gasification chamber;
the secondary combustion chamber adopts a temperature, time and turbulence+excess oxygen (3T+E) low-nitrogen combustion process, and is internally equipped with multi-stage air supply and multiple partitions; and
a flue gas outlet of the secondary combustion chamber is connected with the incineration flue gas purification system.

Optionally, the incineration flue gas purification system includes a heat exchanger, a quencher, a dust collector, a wet deacidification tower, a dehydrator, a de-whitening tower, molecular cracking equipment and a chimney;
where, the heat exchanger is connected to the flue gas outlet of the secondary combustion chamber, and a flue gas temperature is reduced from 850 degrees Celsius (° C.) to 500° C. through waste gas heat exchange, and generated waste heat is used for flue gas de-whitening of the de-whitening tower;
the quencher is connected to a flue gas outlet of the heat exchanger, and the flue gas temperature is reduced from 500° C. to 200° C. through a flue gas quenching process; the quencher is also accompanied by a quencher water tank and a quencher pump;
the dust collector is connected to a flue gas outlet of the quencher, and eight ceramic fiber dust removal pipes are built in for filtering particles in flue gas passing through; the dust collector is also equipped with an activated carbon injection device at a front end to carry out preliminary adsorption treatment on gaseous pollutants in the flue gas;
the wet deacidification tower is connected to a flue gas outlet of the dust collector for neutralizing and absorbing and removing acid gas components in the flue gas by wet spraying lye, where the spraying lye is a prepared sodium hydroxide aqueous solution; and the wet deacidification tower is also accompanied by a lye tank and a lye pump;
the dehydrator is connected to a flue gas outlet of the wet deacidification tower, and is used to remove moisture in the flue gas treated by the wet deacidification tower and ensure normal operation of the molecular cracking equipment;
the de-whitening tower is connected to a flue gas outlet of the dehydrator for de-whitening the flue gas in a process by using the generated waste heat in the waste gas heat exchange of the heat exchanger;
the molecular cracking equipment is connected to a flue gas outlet of the de-whitening tower for using a low-temperature plasma molecular cracking technology to realize efficient capture of trace dioxins in the flue gas by massive high-energy free radicals and bond breaking of physical and chemical molecules during a low-temperature plasma reaction process, thus realizing deep purification of flue gas; and
the chimney is connected to a flue gas outlet of the molecular cracking equipment, and equipped with lifting parts.

Optionally, the intelligent management and control system for medical waste disposal includes a cloud command system and an intelligent operating system; the intelligent management and control system for medical waste disposal may is used for realizing functions of medical waste information tracing, intelligent medical waste treatment equipment control, environmental protection monitoring, disinfection and fire fighting and vehicle management;
where, the cloud command system is under an overall command of the intelligent operating system set on the site, and is linked to a vehicle intelligent control system, a security system and an information traceability system through a communication bus;
a plurality of local sub-servers are deployed under the intelligent operating system and are interconnected through wireless communication to meet practical use needs of grass-roots and remote epidemic areas; and
the cloud command system deploys a plurality of mobile terminals and local monitoring systems to realize functions of video monitoring, process monitoring and environmental protection monitoring; the local sub-servers, the mobile terminals and the local monitoring systems are all linked to the communication bus to realize mutual communication and issue instructions and supervision to the vehicle intelligent control system, the security system and the information traceability system.

Optionally, the vehicle intelligent control system receives a command transmitted by the communication bus, and is used for controlling the intelligent mechanical arm to scan a code of a garbage collection point, collecting information, completing garbage weighing, and transporting garbage to the medical waste pyrolysis incineration system, monitoring process control data in real time, intelligently adjusting the equipment according to garbage components, calorific value and equipment state, controlling an automatic slag discharge system to collect and automatically discharge residue, and weighing and marking, and finally sending the residue to a landfill, where waste liquid is used to suppress dust of the residue, and controlling continuous emission monitoring system (CEMS) monitoring equipment to monitor exhaust components in real time;
the security system receives the command transmitted by the communication bus and is used for controlling the high-temperature sterilization equipment, the spray sterilization equipment and the ultraviolet sterilization equipment installed inside and outside the skid-mounted standard container to perform disinfection functions, controlling a vehicle-mounted independent fire extinguisher or a hydrant system of the vehicle-mounted fire fighting equipment, setting acousto-optic alarms for equipment reminders, faults, anomalies and accidents, and collecting status in real time, and transmitting to the intelligent operating system, the local sub-servers, the mobile terminals and the local monitoring systems by the communication bus; and the security system functionally links the cloud command system and the intelligent operating system at the same time; and
the information traceability system receives the command transmitted by the communication bus, and is used for realizing process dynamic information traceability by purchasing information such as garbage disposal system, vehicle, personnel, fire fighting and geographical location; and the information traceability system functionally links the cloud command system and the intelligent operating system at the same time.

Optionally, the intelligent operating system includes an information traceability system, a garbage collection system, a vehicle management system, a garbage disposal system, a gas detection system and a security system; all functional blocks of the intelligent operating system are linked to a terminal database of the cloud command system to ensure stable operation of each function of an in-vehicle part and an out-of-vehicle part;
in the garbage collection system, the medical waste is transported by a garbage transfer vehicle to the intelligent mobile medical waste disposal and flue gas purification equipment, and then handed over to the intelligent mechanical arm for a next process;
the vehicle management system collects vehicle action trajectory, locates the vehicle in real time, and transmits information to the information traceability system after field equipment issues a medical waste disposal task;
the garbage disposal system is connected with a control cabinet of the intelligent mobile medical waste disposal and flue gas purification equipment, and monitors operating status of the intelligent collection and transportation feeding system, the medical waste pyrolysis incineration system and the incineration flue gas purification system in real time, intelligently controls various process parameters of garbage feeding, pyrolysis gasification, flue gas treatment and waste residue and waste liquid treatment, and reports the process parameters to the terminal database of the cloud command system; and
the gas detection system is connected with the CEMS monitoring equipment, a pressure gauge and a temperature sensor, and collects smoke emission data in real time and reports the data to the terminal database of the cloud command system.

The disclosure also provides an intelligent mobile medical waste disposal and flue gas purification method based on the intelligent mobile medical waste disposal and flue gas purification equipment, including following steps:
transporting grass-roots mixed medical waste and epidemic infectious medical waste to a location of the intelligent mobile medical waste disposal and flue gas purification equipment through an Internet of things (IoT) garbage collection system, and automatically feeding the medical waste pyrolysis incineration system by the intelligent mechanical arm;
selecting a pyrolysis process by the pyrolysis gasification chamber according to use requirements, and raising a temperature to a corresponding value through a rapid temperature-raising program and a rapid temperature increase and control module, realizing rapid pyrolysis and efficient volume reduction of the medical waste;
transporting pyrolysis gas discharged from the pyrolysis gasification chamber and pyrolysis condensate oil to the secondary combustion chamber to complete deep decomposition of volatile organic compounds (VOCs), persistent organic pollutants (POPs) and other difficult-to-remove organic components in flue gas;
sending the flue gas from the outlet of the secondary combustion chamber to the heat exchanger to complete a waste gas heat exchange step, reducing the temperature from 850° C. to 500° C., and using generated waste heat in a link of the de-whitening tower;
completing a flue gas quenching step for flue gas from the outlet of the heat exchanger through the quencher, reducing the temperature from 500° C. to 200° C.;
completing a flue gas dust removal step for flue gas from the outlet of the quencher through the dust collector;
completing a flue gas deacidification step for flue gas from the outlet of the dust collector through the wet deacidification tower to remove acid gases such as hydrogen chloride, sulfur dioxide, nitrogen oxides, where a deacidification process uses a lye atomization spraying mode, and lye is a prepared sodium hydroxide solution;
completing a flue gas dehydration and defogging step for flue gas from the outlet of the wet deacidification tower through the dehydrator;
completing a flue gas de-whitening step for flue gas from the outlet of the dehydrator through the de-whitening tower;
completing a low-temperature plasma molecular cracking deep purification step for flue gas from the outlet of the de-whitening tower through the molecular cracking equipment, realizing efficient decomposition of trace dioxin and other difficult-to-remove pollutants by massive high-energy free radicals in a process of low-temperature plasma discharge, and ultimately ensuring a dioxin emission concentration of ≤0.3 nanogram toxic equivalent quantity/normal cubic meter (ng TEQ/Nm3);
discharging flue gas from the outlet of the molecular cracking equipment to atmosphere through the chimney; and
collecting fly ash, particles, etc. filtered by the dust collector in internal ceramic fiber pipes, and sending fly ash, particles, etc. to a specific site for landfill after a proper treatment; sending waste residue generated by the pyrolysis gasification chamber to a specific site for landfill after collection and pretreatment of spraying dust suppression; and recovering pyrolysis gas generated by the pyrolysis gasification chamber as condensed oil after condensation.

Compared with the prior art, the disclosure has following beneficial effects.

Firstly, in terms of optimization and integration of miniaturized in-situ pyrolysis incineration equipment, by developing a supporting vehicle platform (including key components such as automatic control system, energy supply, safety and environmental protection), the miniaturization, batch and unitization of equipment are promoted, and the integration of miniaturized mobile skid-mounted pyrolysis incineration complete equipment is realized, thus meeting the requirements of in-situ safe disposal of medical waste in remote areas, foreign aid, disaster relief and other scenarios.

Secondly, in terms of digital intelligent management and control platform, intelligent supervision and intelligent optimization of full-space search are realized by developing multi-joint intelligent mechanical arms, researching unmanned intelligent collection and transportation technology, developing intelligent sensing equipment and whole-process traceable digital management and control system, and adopting full-space search intelligent optimization algorithm and multi-objective intelligent optimization algorithm.

Thirdly, in terms of technology and equipment for deep purification of exhaust pollution components, the generation characteristics and control mechanism of air pollutants in the process of medical waste pyrolysis incineration with different components are studied, and the key technology of low-temperature plasma molecular pyrolysis is adopted to realize deep purification of dioxin in the exhaust. Key unit technologies such as dust removal, deacidification, denitrification, demisting and molecular cracking are optimized and integrated to form a complete set of exhaust purification equipment, so as to overcome technical problems such as great changes in flue gas pollution components and concentrations, high requirements for miniaturization of equipment, and frequent and rapid start-stop adaptability.

### BRIEF DESCRIPTION OF THE DRAWINGS

Illustrative embodiments of the present disclosure are described in detail below with reference to the attached drawing figures and wherein:

FIG. 1 is a block diagram of an intelligent mobile medical waste disposal and flue gas purification equipment, according to an embodiment of the disclosure.

FIG. 2 is an overall schematic diagram of the intelligent mobile medical waste disposal and flue gas purification equipment, according to an embodiment of the disclosure.

FIG. 3 is a detailed schematic diagram of a skid-mounted standard container and contents thereof, according to an embodiment of the disclosure.

FIG. 4 is a structural diagram of a cloud command system, according to an embodiment of the disclosure.

FIG. 5 is a structural diagram of an intelligent operating system, according to an embodiment of the disclosure.

FIG. 6 is a flow chart of an intelligent mobile medical waste disposal and flue gas purification method, according to an embodiment of the disclosure.

### DETAILED DESCRIPTION OF THE EMBODIMENTS

In the following, the technical scheme in the embodiment of the disclosure will be clearly and completely described with reference to the attached drawings. Obviously, the described embodiments are only a part of the embodiments of the disclosure, but not all the embodiments. Based on the embodiments in the disclosure, all other embodiments obtained by ordinary technicians in the field without creative labour belong to the protection scope of the disclosure.

In order to make the above objects, features and advantages of the disclosure more obvious and easy to understand, the disclosure will be further described in detail with the attached drawings and specific embodiments.

### Embodiment 1

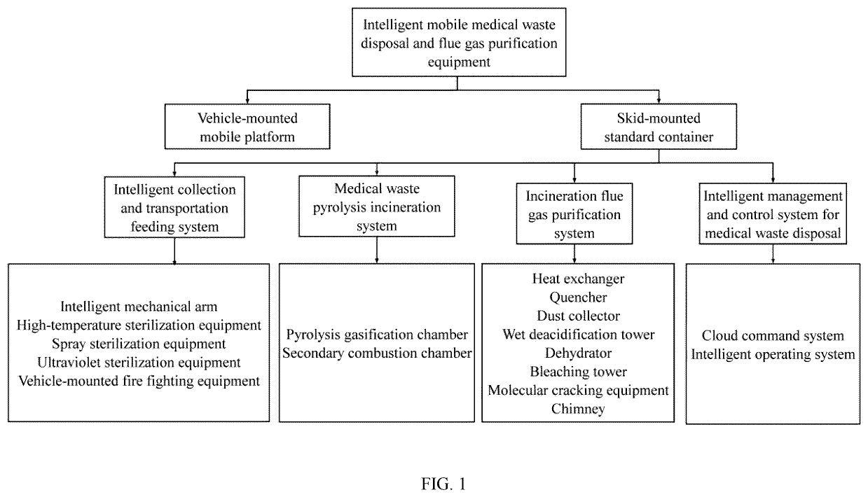

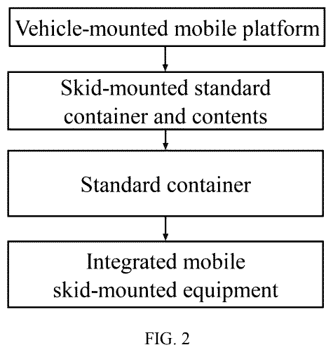

As shown in FIG. 1 and FIG. 2, the disclosure provides an intelligent mobile medical waste disposal and flue gas purification equipment, which consists of a vehicle-mounted mobile platform and a skid-mounted standard container.

The vehicle-mounted mobile platform is a standardized trailer platform, and is composed of a standard semi-trailer truck and a truck carriage base, and may realize basic functions such as mobile transportation, cargo loading, fuel loading and unloading, power charging and discharging, network information transmission, etc. The specifications of the energy supply system are: 120 kilowatt (KW) load balance, electric-oil duplex automatic energy supply. The skid-mounted standard container may be loaded on the truck carriage base of the vehicle-mounted mobile platform.

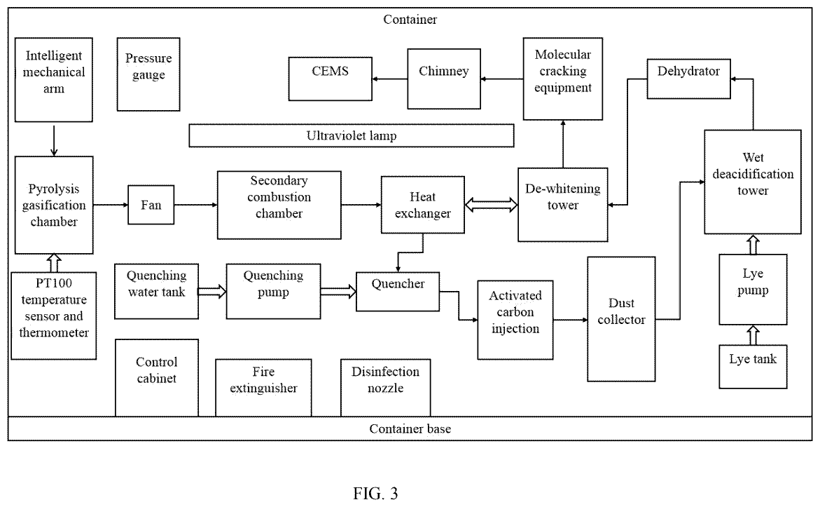

As shown in FIG. 3, a skid-mounted standard container consists of a standard container that includes contents shown in FIG. 3. The standard container is a 40-inch standard container with detailed dimensions of 12.192 meters (m) (length)×2.438 m (width)×2.591 m (height). The placement of the standard container requires that the centre of gravity be stable and centred. The contents include one or more units that, in embodiments, constitute the medical waste disposal equipment of the disclosure. In an aspect, the contents include: an intelligent collection and transportation feeding system, a medical waste pyrolysis incineration system, an incineration flue gas purification system, and an intelligent management and control system for medical waste disposal.

In an embodiment, the intelligent collection and transportation feeding system includes an intelligent mechanical arm, high-temperature sterilization equipment, spray sterilization equipment, ultraviolet sterilization equipment and vehicle-mounted fire fighting equipment (see FIG. 1).

The intelligent mechanical arm is automatically controlled by the intelligent management and control system for medical waste disposal, and automatically feeds the medical waste pyrolysis incineration system to realize unattended “zero contact” with medical waste.

The high-temperature sterilization equipment, the spray sterilization equipment and the ultraviolet sterilization equipment are combined together to complete compound sterilization of the intelligent mobile medical waste disposal and flue gas purification equipment. The specifications, in one example, are: high-temperature sterilization temperature of ≥100° C., spray sterilization area of ≥200 square metre (m2), ultraviolet irradiation intensity of ≥100 microwatt/square centimetre (uw/cm2), and sterilization area of a complete set of ultraviolet sterilization lamps of ≥100 m2. The “zero diffusion” of medical waste infectivity is realized.

The vehicle-mounted fire fighting equipment is automatically controlled by the intelligent management and control system for medical waste disposal, and a standard fire extinguisher and a fire alarm probe are built in for an emergency fire extinguishing function in an event of an unconventional fire in the intelligent mobile medical waste disposal and flue gas purification equipment.

In this embodiment, the medical waste pyrolysis incineration system includes a pyrolysis gasification chamber and a secondary combustion chamber. The overall operation specifications of the medical waste pyrolysis incineration system are: continuous operation time of ≥168 hours (h), daily treatment scale of 1-3 ton (t), volume reduction rate of ≥95%, rapid pyrolysis efficiency of ≥99.9%, hot start-up time of ≤10 minutes (m), and time of increasing temperature to 850° C. of ≤1 h. The intelligent mechanical arm is used to automatically feed the feeding port of the pyrolysis gasification chamber.

The pyrolysis gasification chamber adopts rapid pyrolysis temperature-increasing components and an adaptive tower-type rotating grate, and spiral fins are added to an inner/outer wall surface of a pyrolysis cylinder. The operation efficiency may reach volume reduction rate of ≥95%, rapid pyrolysis efficiency of ≥99.9%, hot start-up time of ≤10 min, and time of increasing temperature to 850° C. of ≤1 h. Two different operating conditions, high temperature pyrolysis (850° C.) and moderate temperature pyrolysis (450° C.) are configured according to the application needs of the site. A flue gas outlet of the pyrolysis gasification chamber is connected with the inlet of the secondary combustion chamber.

The secondary combustion chamber adopts a “3T+E” low-nitrogen combustion technology, and is internally equipped with multi-stage air supply and multiple partitions. The operating temperature is ≥850° C., which reduces the heating energy consumption and the emission smoke pollution concentration. A flue gas outlet of the secondary combustion chamber is connected with the incineration flue gas purification system.

In this embodiment, the incineration flue gas purification system includes a heat exchanger, a quencher, a dust collector, a wet deacidification tower, a dehydrator, a de-whitening tower, molecular cracking equipment and a chimney. Through step-by-step flue gas purification, the final concentration of pollutants emitted from the chimney is strictly controlled according to the EU DIRECTIVE2010 standard, and the dioxin emission concentration is ≤0.3 ng TEQ/Nm3. The extra waste liquid and waste residue generated by the system are properly disposed of.

The heat exchanger is connected to the flue gas outlet of the secondary combustion chamber, and the flue gas temperature may be reduced from 850° C. to 500° C. through waste gas heat exchange, and the generated waste heat may be used for flue gas de-whitening of the de-whitening tower.

The quencher is connected to a flue gas outlet of the heat exchanger, and the flue gas temperature may be reduced from 500° C. to 200° C. through the flue gas quenching process. The quencher is also accompanied by a quencher water tank and a quencher pump.

The dust collector is connected to a flue gas outlet of the quencher, and eight ceramic fibre dust removal pipes are built in, which may filter particles in flue gas passing through. Moreover, the dust collector is also equipped with an activated carbon injection device at a front end to carry out preliminary adsorption treatment on gaseous pollutants in the flue gas.

The wet deacidification tower is connected to a flue gas outlet of the dust collector for neutralizing and absorbing and removing acid gas components in the flue gas by wet spraying lye, where the spraying lye is a prepared sodium hydroxide aqueous solution; and the wet deacidification tower is also accompanied by a lye tank and a lye pump.

The dehydrator is connected to a flue gas outlet of the wet deacidification tower, and is used to remove moisture in the flue gas treated by the wet deacidification tower and ensure normal operation of the molecular cracking equipment.

The de-whitening tower is connected to a flue gas outlet of the dehydrator for de-whitening the flue gas in a process by using the generated waste heat in the waste gas heat exchange of the heat exchanger, and the effective de-whitening temperature is ≥150° C.

The molecular cracking equipment is connected to a flue gas outlet of the de-whitening tower for using a low-temperature plasma molecular cracking technology to realize efficient capture of trace dioxins in the flue gas by massive high-energy free radicals and bond breaking of physical and chemical molecules during a low-temperature plasma reaction process, thus realizing deep purification of flue gas. The dioxin emission concentration after treatment is ≤0.3 ng TEQ/Nm3. Equipment operating conditions: voltage≥20 kilovolt (kV), frequency≥1000 hertz (Hz), pulse width≤500 nanoseconds (ns), rising edge≤50 ns.

The chimney is connected to a flue gas outlet of the molecular cracking equipment, and equipped with lifting parts. When the intelligent mobile medical waste disposal and flue gas purification equipment is stopped and the medical waste is pyrolyzed and incinerated, the height of the chimney may be raised by ≥5 m to meet the national standard requirements. When the intelligent mobile medical waste disposal and flue gas purification equipment starts to move, the chimney may be lowered and retracted into the skid-mounted standard container.

In this embodiment, the intelligent management and control system for medical waste disposal includes a cloud command system and an intelligent operating system. The intelligent management and control system for medical waste disposal may realize functions of medical waste information tracing, intelligent medical waste treatment equipment control, environmental protection monitoring, disinfection and fire fighting, vehicle management and so on.

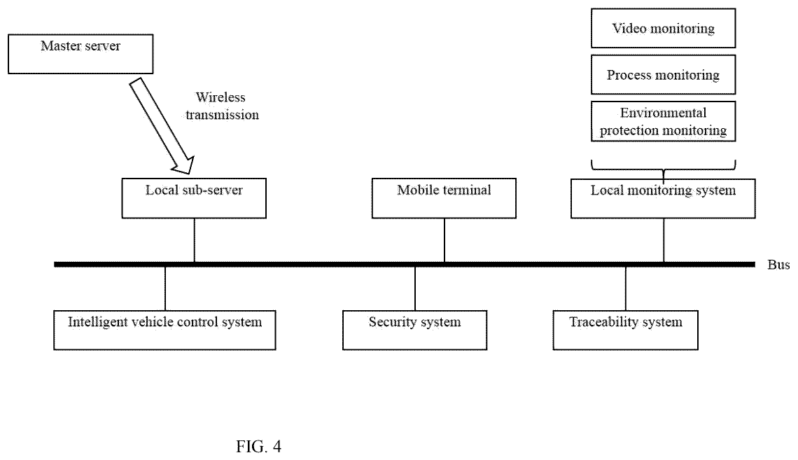

As shown in FIG. 4, the cloud command system is under an overall command of the intelligent operating system set on the site, and is linked to a vehicle intelligent control system, a security system and an information traceability system through a communication bus. A plurality of local sub-servers are deployed under the intelligent operating system and are interconnected through wireless communication to meet practical use needs of grass-roots and remote epidemic areas.

In addition, the cloud command system may deploy a plurality of mobile terminals and local monitoring systems to realize functions of video monitoring, process monitoring and environmental protection monitoring. The local sub-servers, the mobile terminals and the local monitoring systems are all linked to the communication bus to realize mutual communication and issue instructions and supervision to the vehicle intelligent control system, the security system and the information traceability system.

The vehicle intelligent control system may receive the command transmitted by the communication bus and perform the following functions: controlling the intelligent mechanical arm to scan a code of a garbage collection point, collecting information, completing garbage weighing, and transporting garbage to the medical waste pyrolysis incineration system; monitoring process control data in real time, intelligently adjusting the equipment according to garbage components, calorific value and equipment state; controlling an automatic slag discharge system to collect and automatically discharge residue, and weighing and marking, and finally sending the residue to a landfill, where waste liquid is used to suppress dust of the residue; and controlling CEMS monitoring equipment to monitor exhaust components in real time.

The security system may receive the command transmitted by the communication bus and perform the following functions: controlling the high-temperature sterilization equipment, the spray sterilization equipment and the ultraviolet sterilization equipment installed inside and outside the skid-mounted standard container to perform disinfection functions; controlling a vehicle-mounted independent fire extinguisher or a hydrant system of the vehicle-mounted fire fighting equipment, setting acousto-optic alarms for equipment reminders, faults, anomalies and accidents, and collecting status in real time, and transmitting to the intelligent operating system, the local sub-servers, the mobile terminals and the local monitoring systems by the communication bus. The security system functionally links the cloud command system and the intelligent operating system at the same time.

The information traceability system may receive the command transmitted by the communication bus and perform following functions: realizing process dynamic information traceability by purchasing information such as garbage disposal system, vehicle, personnel, fire fighting and geographical location. The information traceability system functionally links the cloud command system and the intelligent operating system at the same time.

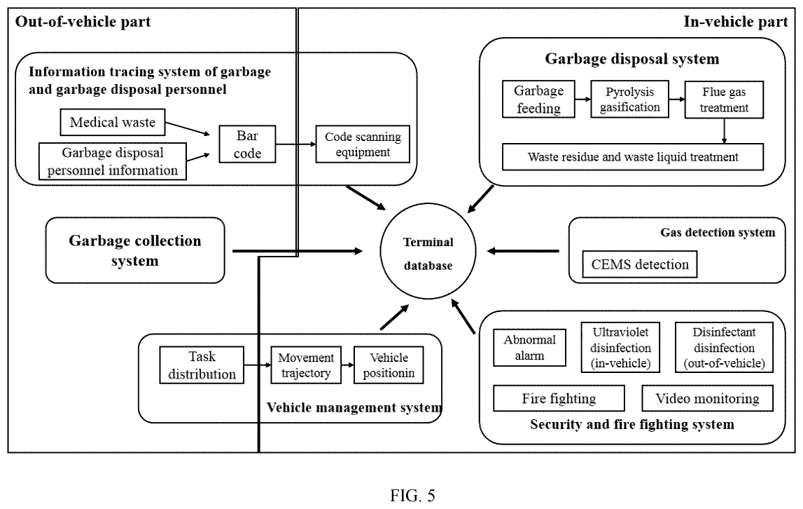

As shown in FIG. 5, the intelligent operating system includes an information traceability system, a garbage collection system, a vehicle management system, a garbage disposal system, a gas detection system and a security system. All functional blocks of the intelligent operating system are linked to a terminal database of the cloud command system to ensure stable operation of each function of an in-vehicle part and an out-of-vehicle part.

In the garbage collection system, the medical waste is transported by a garbage transfer vehicle to the intelligent mobile medical waste disposal and flue gas purification equipment, and then handed over to the intelligent mechanical arm for a next process.

The vehicle management system may collect vehicle action trajectory, locate the vehicle in real time, and transmit information to the information traceability system after field equipment issues a medical waste disposal task.

The garbage disposal system is connected with a control cabinet of the intelligent mobile medical waste disposal and flue gas purification equipment, and may monitor operating status of the intelligent collection and transportation feeding system, the medical waste pyrolysis incineration system and the incineration flue gas purification system in real time, intelligently control various process parameters of garbage feeding, pyrolysis gasification, flue gas treatment and waste residue and waste liquid treatment, and report the process parameters to the terminal database of the cloud command system.

The gas detection system is connected with the CEMS monitoring equipment, a pressure gauge and a temperature sensor, and may collect smoke emission data in real time and report the data to the terminal database of the cloud command system.

### Embodiment 2

This embodiment provides an intelligent mobile medical waste disposal and flue gas purification method based on the intelligent mobile medical waste disposal and flue gas purification equipment. The following contents are the corresponding process flow of the intelligent mobile medical waste disposal and flue gas purification equipment in the actual process of treating medical waste and purifying flue gas, mainly including the following contents.

### I. Material Exchange Process

Firstly, grass-roots mixed medical waste and epidemic infectious medical waste are transported to the location of the intelligent mobile medical waste disposal and flue gas purification equipment through the IoT garbage collection system, and the intelligent mechanical arm automatically feeds the medical waste pyrolysis incineration system to complete the material layer exchange from the outside to the inside.

Secondly, the incineration flue gas treated by the incineration flue gas purification system is discharged to the external atmosphere through the chimney, and the pollutant concentration of the flue gas discharge is strictly controlled in accordance with the EU DIRECTIVE2010 standard, and the dioxin emission concentration is ≤0.3 ng TEQ/Nm3; fly ash and particles filtered by the dust collector are collected in the internal ceramic fibre pipes and buried after a proper treatment; the waste residue generated by the pyrolysis gasification chamber is collected and pretreated and then buried; the pyrolysis gas generated by the pyrolysis gasification chamber is condensed and then recovered as condensed oil. The above steps complete the material layer exchange from the inside to the outside.

### II. Information Exchange Process

The IoT garbage collection system communicates with the intelligent management and control system for medical waste disposal to realize functions such as medical waste information tracing, intelligent medical waste treatment equipment control, environmental protection monitoring, disinfection and fire fighting, vehicle management. The intelligent management and control system for medical waste disposal completes data acquisition and real-time monitoring through various instruments and meters. The generated fly ash, waste residue, waste oil, etc. may be collected properly, traced back by quick response code (QR code) information, and counted by database, so as to realize the unified control of the whole process material exchange process by the intelligent management and control system for medical waste disposal and meet the practical use requirements of intelligent traceability in the whole process of medical waste disposal.

### III. Energy Exchange Process

The medical waste transported to the medical waste pyrolysis incineration system is firstly subjected to a pyrolysis process selected by the pyrolysis gasification chamber according to the needs of the use (high temperature pyrolysis 850° C., moderate temperature pyrolysis 450° C.), and the temperature is raised to a corresponding value through the rapid temperature-raising program; the pyrolysis flue gas is sent to the secondary combustion chamber for further incineration; after the waste gas heat exchange step for the flue gas from the outlet of the secondary combustion chamber through the heat exchanger, the temperature is reduced from 850° C. to 500° C., and the generated waste heat is used in a link of the de-whitening tower; after the flue gas quenching link for the flue gas from the outlet of the heat exchanger through the quencher, the temperature is reduced from 500° C. to 200° C., and then the flue gas passes through the de-whitening tower, and the de-whitening of the flue gas is completed at the temperature≥150° C. The energy utilization of the whole process is reasonable, embodying the intelligent energy exchange process of pyrolysis incineration and flue gas purification.

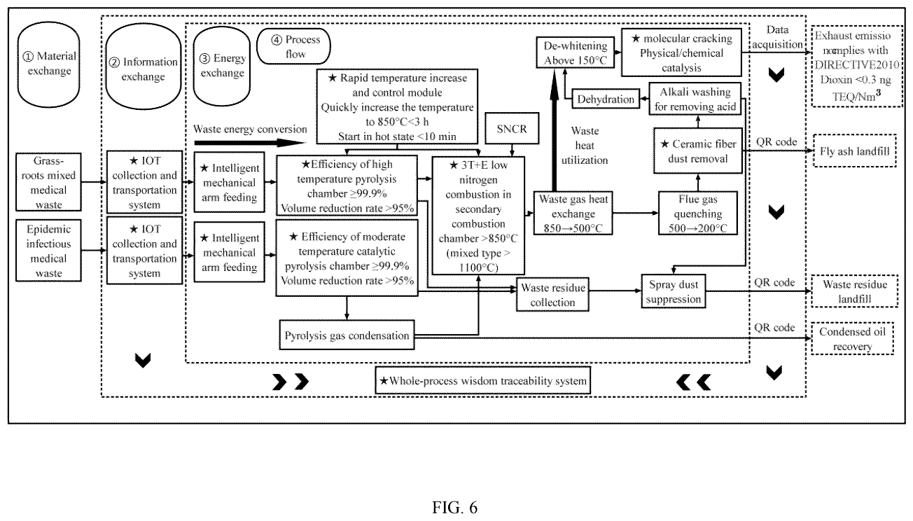

### IV. Process Flow of Equipment Operation as Shown in FIG. 6

1. Grass-roots mixed medical waste and epidemic infectious medical waste are transported to the location of the intelligent mobile medical waste disposal and flue gas purification equipment through the IoT garbage collection system, and the intelligent mechanical arm automatically feeds the medical waste pyrolysis incineration system.

2. A pyrolysis process (high temperature pyrolysis 850° C., moderate temperature pyrolysis 450° C.) is selected by the pyrolysis gasification chamber according to use requirements, and a temperature is raised to a corresponding value through a rapid temperature-raising program and a rapid temperature increase and control module to realize rapid pyrolysis and efficient volume reduction of the medical waste. Technical specifications of the pyrolysis gasification chamber are: volume reduction rate≥95%, rapid pyrolysis efficiency≥99.9%, hot start-up time≤10 min, the time of increasing temperature to 850° C.≤1 h, and daily medical waste treatment capacity of 1-2 t.

3. Pyrolysis gas discharged from the pyrolysis gasification chamber and pyrolysis condensate oil are transported to the secondary combustion chamber to complete deep decomposition of VOCs, POPs and other difficult-to-remove organic components in the flue gas. The secondary combustion chamber adopts “3T+E” low nitrogen combustion process, and the operating temperature is ≥850° C.

4. The flue gas from the outlet of the secondary combustion chamber is sent to the heat exchanger to complete a waste gas heat exchange step, the temperature is reduced from 850° C. to 500° C., and the generated waste heat is used in a link of the de-whitening tower.

5. A flue gas quenching step for the flue gas from the outlet of the heat exchanger is completed through the quencher, and the temperature is reduced from 500° C. to 200° C.

6. A flue gas dust removal step for the flue gas from the outlet of the quencher is completed through the dust collector, and a dust removal process adopts eight ceramic fibre filter tubes, and the fly ash in the flue gas may be filtered and removed by the gas flowing through the ceramic tubes. The process parameters are: gas volume 1000 normal cubic metre/hour (Nm3/h), filter tube length 1200 millimetre (mm), filter area 0.3 m2, gas flow rate 0.93 metre/second (m/s), residence time 1.29 seconds(s), economic temperature≤450° C., total pressure 700 pascal (pa), size 1200×1000 mm×1950 mm.

7. A flue gas deacidification step for the flue gas from the outlet of the dust collector is completed through the wet deacidification tower to remove acid gases such as hydrogen chloride, sulphur dioxide, nitrogen oxides, and a deacidification process uses a lye atomization spraying mode, and the lye is a prepared sodium hydroxide solution. The process parameters are: gas volume of 1000 Nm3/h, washing flow of 6 cubic metre/hour (m3/h), equipment material of 304 stainless steel, total pressure of 100-120 pa, and size of 1000×700 mm×1950 mm.

8. A flue gas dehydration and defogging step for the flue gas from the outlet of the wet deacidification tower is completed through the dehydrator to prevent a large amount of moisture in the flue gas from affecting the subsequent process units. The process parameters are: gas volume of 1000 Nm3/h, equipment material of 304 stainless steel, filter area of 1.06 m2, gas flow rate of 0.26 m/s, residence time of 4.98 s, and medium layer of gas equalizing plate, structured de-watering layer, wire mesh de-watering layer and powerless separator, total pressure of 80-100 pa and size of 1100×1100 mm×1950 mm.

9. A flue gas de-whitening step for the flue gas from the outlet of the dehydrator is completed through the de-whitening tower. The process parameters are: gas volume of 1000 Nm3/h, equipment material of 304 stainless steel, initial temperature of 50° C., heating temperature of ≥150° C., total pressure of 50-80 pa, power of 100 kw and equipment size of 550×900×1950 mm.

10. A low-temperature plasma molecular cracking deep purification step for the flue gas from the outlet of the de-whitening tower is completed through the molecular cracking equipment, realizing efficient decomposition of trace dioxin and other difficult-to-remove pollutants by massive high-energy free radicals in a process of low-temperature plasma discharge, and ultimately ensuring a dioxin emission concentration of ≤0.3 ng TEQ/Nm3. The process parameters are: voltage of 40 kv, power supply of 5 kw, frequency of 1-1000 Hz, pulse width of 700-800 ns, power supply mode of 380 volt (v) three-phase four-wire system, gas volume of 1000 Nm3/h, equipment material of 316 stainless steel, gas flow rate of 2.8 m/s, residence time of 0.28 s, number of bobbins of 16, one unit, pressure of 120-180 pa, temperature of ≤50-70° C., and size of 1200×1200×1950 mm.

11. The flue gas from the outlet of the molecular cracking equipment is discharged to the atmosphere through the chimney. The chimney is equipped with lifting parts. When the intelligent mobile medical waste disposal and flue gas purification equipment is stopped and the medical waste is pyrolyzed and incinerated, the chimney may be lifted to a height of ≥5 m to meet the national standard requirements. When the intelligent mobile medical waste disposal and flue gas purification equipment starts to move, the chimney may be lowered and retracted into the skid-mounted standard container.

12. The fly ash, particles, etc. filtered by the dust collector are collected in internal ceramic fibre pipes, and sent to a specific site for landfill after the proper treatment; the waste residue generated by the pyrolysis gasification chamber is sent to a specific site for landfill after collection and pretreatment of spraying dust suppression; and the pyrolysis gas generated by the pyrolysis gasification chamber is recovered as condensed oil after condensation.

The above-mentioned embodiment is only a description of the preferred mode of the disclosure, and does not limit the scope of the disclosure. Under the premise of not departing from the design spirit of the disclosure, various modifications and improvements made by ordinary technicians in the field to the technical scheme of the disclosure shall fall within the protection scope determined by the claims of the disclosure.

What is claimed is:

1. An intelligent mobile medical waste disposal and flue gas purification equipment, comprising:
a vehicle-mounted mobile platform, the vehicle-mounted mobile platform including a standard semi-trailer truck and a truck carriage base; and
a skid-mounted standard container comprising each of an intelligent collection and transportation feeding system, a medical waste pyrolysis incineration system, an incineration flue gas purification system, and an intelligent management and control system for medical waste disposal,
wherein:
the vehicle-mounted mobile platform is used for each of mobile transportation, cargo loading, fuel loading and unloading, power charging and discharging, and network information transmission; and
the skid-mounted standard container is loaded above the truck carriage base of the vehicle-mounted mobile platform.

2. The intelligent mobile medical waste disposal and flue gas purification equipment according to claim 1, wherein:
the intelligent collection and transportation feeding system comprises an intelligent mechanical arm, a high-temperature sterilization equipment, a spray sterilization equipment, an ultraviolet sterilization equipment, and a vehicle-mounted fire fighting equipment;
the intelligent mechanical arm is automatically controlled by the intelligent management and control system for medical waste disposal, and automatically feeds the medical waste pyrolysis incineration system;
the high-temperature sterilization equipment, the spray sterilization equipment and the ultraviolet sterilization equipment are combined together to complete compound sterilization of the intelligent mobile medical waste disposal and flue gas purification equipment; and
the vehicle-mounted fire fighting equipment is automatically controlled by the intelligent management and control system for medical waste disposal, and a standard fire extinguisher and a fire alarm probe are built in for an emergency fire extinguishing function in an event of an unconventional fire of the intelligent mobile medical waste disposal and flue gas purification equipment.

3. The intelligent mobile medical waste disposal and flue gas purification equipment according to claim 2, wherein:
the medical waste pyrolysis incineration system comprises a pyrolysis gasification chamber and a secondary combustion chamber; and
a flue gas outlet of the pyrolysis gasification chamber is connected with an inlet of the secondary combustion chamber.

4. The intelligent mobile medical waste disposal and flue gas purification equipment according to claim 3, wherein:
the incineration flue gas purification system comprises a heat exchanger, a quencher, a dust collector, a wet deacidification tower, a dehydrator, a de-whitening tower, molecular cracking equipment and a chimney;
the heat exchanger is connected to the flue gas outlet of the secondary combustion chamber, and a flue gas temperature is reduced from 850 degrees Celsius to 500 degrees Celsius through waste gas heat exchange, and generated waste heat is used for flue gas de-whitening of the de-whitening tower;
the quencher is connected to a flue gas outlet of the heat exchanger, and the flue gas temperature is reduced from 500 degrees Celsius to 200 degrees Celsius through a flue gas quenching process; the quencher is also accompanied by a quencher water tank and a quencher pump;
the dust collector is connected to a flue gas outlet of the quencher, and eight ceramic fibre dust removal pipes are built in for filtering particles in flue gas passing through; the dust collector is also equipped with an activated carbon injection device at a front end to carry out preliminary adsorption treatment on gaseous pollutants in the flue gas;
the wet deacidification tower is connected to a flue gas outlet of the dust collector for neutralizing and absorbing and removing acid gas components in the flue gas by wet spraying lye, wherein the spraying lye is a prepared sodium hydroxide aqueous solution; and the wet deacidification tower is also accompanied by a lye tank and a lye pump;
the dehydrator is connected to a flue gas outlet of the wet deacidification tower, and is used to remove moisture in the flue gas treated by the wet deacidification tower and ensure normal operation of the molecular cracking equipment;
the de-whitening tower is connected to a flue gas outlet of the dehydrator for de-whitening the flue gas in a process by using the generated waste heat in the waste gas heat exchange of the heat exchanger;
the molecular cracking equipment is connected to a flue gas outlet of the de-whitening tower for using a low-temperature plasma molecular cracking technology to realize efficient capture of trace dioxins in the flue gas by massive high-energy free radicals and bond breaking of physical and chemical molecules during a low-temperature plasma reaction process, thus realizing deep purification of flue gas; and
the chimney is connected to a flue gas outlet of the molecular cracking equipment, and equipped with lifting parts.

5. The intelligent mobile medical waste disposal and flue gas purification equipment according to claim 2, wherein:
the intelligent management and control system for medical waste disposal comprises a cloud command system and an intelligent operating system; the intelligent management and control system for medical waste disposal may is used for realizing functions of medical waste information tracing, intelligent medical waste treatment equipment control, environmental protection monitoring, disinfection and fire fighting and vehicle management;
the cloud command system is under an overall command of the intelligent operating system set on site, and is linked to a vehicle intelligent control system, a security system and an information traceability system through a communication bus;
a plurality of local sub-servers are deployed under the intelligent operating system and are interconnected through wireless communication to meet practical use needs of grass-roots and remote epidemic areas; and
the cloud command system deploys a plurality of mobile terminals and local monitoring systems to realize functions of video monitoring, process monitoring and environmental protection monitoring; the local sub-servers, the mobile terminals and the local monitoring systems are all linked to the communication bus to realize mutual communication and issue instructions and supervision to the vehicle intelligent control system, the security system and the information traceability system.

6. The intelligent mobile medical waste disposal and flue gas purification equipment according to claim 5, wherein:
the vehicle intelligent control system receives a command transmitted by the communication bus, and is used for controlling the intelligent mechanical arm to scan a code of a garbage collection point, collecting information, completing garbage weighing, and transporting garbage to the medical waste pyrolysis incineration system, monitoring process control data in real time, intelligently adjusting the equipment according to garbage components, calorific value and equipment state, controlling an automatic slag discharge system to collect and automatically discharge residue, and weighing and marking, and finally sending the residue to a landfill, wherein waste liquid is used to suppress dust of the residue, and controlling continuous emission monitoring system monitoring equipment to monitor exhaust components in real time;
the security system receives the command transmitted by the communication bus and is used for controlling the high-temperature sterilization equipment, the spray sterilization equipment and the ultraviolet sterilization equipment installed inside and outside the skid-mounted standard container to perform disinfection functions, controlling a vehicle-mounted independent fire extinguisher or a hydrant system of the vehicle-mounted fire fighting equipment, setting acousto-optic alarms for equipment reminders, faults, anomalies and accidents, and collecting status in real time, and transmitting to the intelligent operating system, the local sub-servers, the mobile terminals and the local monitoring systems by the communication bus; and the security system functionally links the cloud command system and the intelligent operating system at the same time; and
the information traceability system receives the command transmitted by the communication bus, and is used for realizing process dynamic information traceability by purchasing information such as garbage disposal system, vehicle, personnel, fire fighting and geographical location; and the information traceability system functionally links the cloud command system and the intelligent operating system at the same time.

7. The intelligent mobile medical waste disposal and flue gas purification equipment according to claim 6, wherein:
the intelligent operating system comprises an information traceability system, a garbage collection system, a vehicle management system, a garbage disposal system, a gas detection system and a security system; all functional blocks of the intelligent operating system are linked to a terminal database of the cloud command system to ensure stable operation of each function of an in-vehicle part and an out-of-vehicle part;
in the garbage collection system, the medical waste is transported by a garbage transfer vehicle to the intelligent mobile medical waste disposal and flue gas purification equipment, and then handed over to the intelligent mechanical arm for a next process;
the vehicle management system collects vehicle action trajectory, locate the vehicle in real time, and transmit information to the information traceability system after field equipment issues a medical waste disposal task;
the garbage disposal system is connected with a control cabinet of the intelligent mobile medical waste disposal and flue gas purification equipment, and monitors operating status of the intelligent collection and transportation feeding system, the medical waste pyrolysis incineration system and the incineration flue gas purification system in real time, intelligently controls various process parameters of garbage feeding, pyrolysis gasification, flue gas treatment and waste residue and waste liquid treatment, and reports the process parameters to the terminal database of the cloud command system; and
the gas detection system is connected with the continuous emission monitoring system monitoring equipment, a pressure gauge and a temperature sensor, and collects smoke emission data in real time and reports the data to the terminal database of the cloud command system.

8. An intelligent mobile medical waste disposal and flue gas purification method, comprising:
transporting medical waste to a location of an intelligent mobile medical waste disposal and flue gas purification equipment through an Internet of things garbage collection system, and
automatically feeding a medical waste pyrolysis incineration system by an intelligent mechanical arm;
selecting a pyrolysis process by a pyrolysis gasification chamber according to use requirements, and raising a temperature to a corresponding value through a rapid temperature-raising program and a rapid temperature increase and control module, realizing rapid pyrolysis and efficient volume reduction of medical waste;
transporting pyrolysis gas discharged from a pyrolysis gasification chamber and pyrolysis condensate oil to a secondary combustion chamber to complete deep decomposition of volatile organic compounds, persistent organic pollutants and other difficult-to-remove organic components in flue gas;
sending the flue gas from an outlet of the secondary combustion chamber to a heat exchanger to complete a waste gas heat exchange step, reducing a temperature from 850 degrees Celsius to 500 degrees Celsius, and using generated waste heat in a link of a de-whitening tower;
completing a flue gas quenching step for flue gas from an outlet of the heat exchanger through a quencher, reducing the temperature from 500 degrees Celsius to 200 degrees Celsius;
completing a flue gas dust removal step for flue gas from an outlet of the quencher through a dust collector;
completing a flue gas deacidification step for flue gas from an outlet of the dust collector through a wet deacidification tower to remove acid gases such as hydrogen chloride, sulphur dioxide, nitrogen oxides, wherein a deacidification process uses a lye atomization spraying mode, and lye is a prepared sodium hydroxide solution;
completing a flue gas dehydration and defogging step for flue gas from an outlet of the wet deacidification tower through a dehydrator;
completing a flue gas de-whitening step for flue gas from an outlet of the dehydrator through a de-whitening tower;
completing a low-temperature plasma molecular cracking deep purification step for flue gas from an outlet of the de-whitening tower through molecular cracking equipment, realizing efficient decomposition of trace dioxin and other difficult-to-remove pollutants by massive high-energy free radicals in a process of low-temperature plasma discharge, and ultimately ensuring a dioxin emission concentration of ≤0.3 nanogram toxic equivalent quantity/normal cubic metre;
discharging flue gas from an outlet of the molecular cracking equipment to atmosphere through a chimney; and
collecting at least fly ash and particulate matter filtered by the dust collector in internal ceramic fibre pipes, and sending at least fly ash and particulate matter to a specific site for landfill after a proper treatment; sending waste residue generated by the pyrolysis gasification chamber to a specific site for landfill after collection and pretreatment of spraying dust suppression; and recovering pyrolysis gas generated by the pyrolysis gasification chamber as condensed oil after condensation.
